(19) United States
(12) Patent Application Publication
(10) Pub. No.: US 2011/0020759 A1
(43) Pub. Date: Jan. 27, 2011

(54) GAS SUPPLY INTERFACE FOR A WATER HEATER

(76) Inventor: Russell Clayton, Westland, MI (US)

Correspondence Address: Carlson, Gaskey & Olds/Masco Corporation, 400 West Maple Road, Suite 350, Birmingham, MI, 48009, US

(21) Appl. No.: 12/900,729

(22) Filed: Oct. 8, 2010

Related U.S. Application Data
(63) Continuation-in-part of application No. 11/282,931, filed on Nov. 18, 2005.

(51) Int. Cl. F23D 14/46; B23P 19/02

(52) U.S. Cl. 431/159; 29/525

(57) ABSTRACT

A gas supply interface includes a door adapted to fit within an opening to a combustion chamber, the door includes a serrated opening.

### BACKGROUND

The present application is a continuation-in-part application of United States Patent Application No. 11/282,931, filed Nov. 18, 2005, U.S. patent application Ser. No. 12/057279, filed Mar. 27, 2008 and U.S. patent application Ser. No. 12/505,515, filed Jul. 19, 2009.

The present disclosure relates to a gas supply interface for delivering natural gas to a combustion chamber of a water heater.

Devices that utilize a combustible fuel such as propane or natural gas require connections between a multiple of components. Various connections have been provided. Although effective, current connection components are rather expensive and may require a welded or brazed connection which may complicate installation for combustible fuel devices.

### SUMMARY

A gas supply interface according to an exemplary aspect of the present disclosure includes a door adapted to fit within an opening to a combustion chamber and a gas supply tube which defines a flange, the gas supply tube received within a serrated opening such that the flange abuts the door.

A method of assembling a gas supply interface for delivering combustion gases to a device according to an exemplary aspect of the present disclosure includes telescoping a gas supply line to a gas supply tube; inserting the gas supply tube through a serrated opening of a door adapted to fit within an opening to a combustion chamber; and compressing the gas supply tube against the serrated opening.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general side view of a gas supply interface for a water heater embodiment of the present invention;

FIG. 2 is a perspective sectional view of the gas supply interface for the water heater;

FIG. 3 is an exploded view of a gas supply interface;

FIG. 4A is a front view of a door with a serrated opening; and

FIG. 4B is a sectional view taken along line 4B-4B of FIG. 4A.

### DETAILED DESCRIPTION

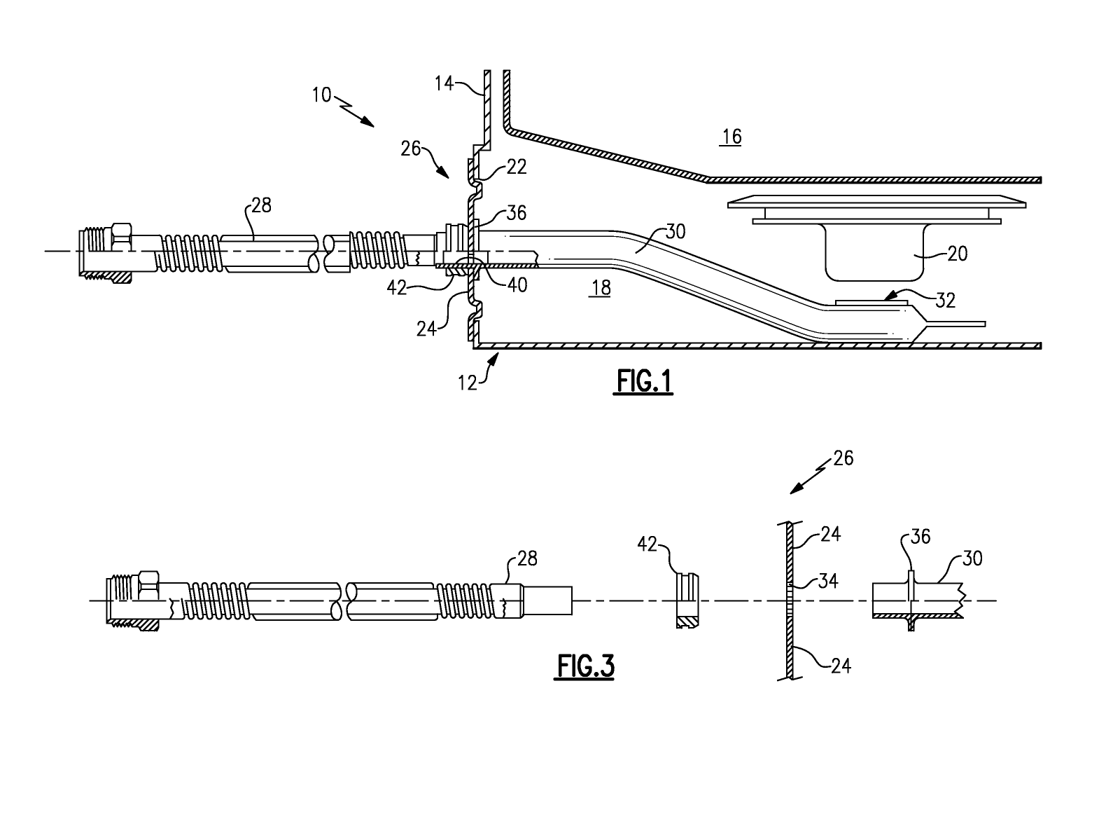

FIG. 1 illustrates a general perspective view of a gas supply assembly 10 for use with a water heater assembly 12. Although a water heater assembly 12 is disclosed in the illustrated embodiment, it should be understood that any other type of device such as a gas range, oven, fireplace, water heater, furnace, cloths dryer, BBQ grill or any other gas or liquid propane type appliance, valve, regulator or other gas control device will benefit herefrom.

The water heater assembly 12 includes a water heater housing 14 that may be compartmentalized to include a water tank 16 and a combustion chamber 18. Disposed within the combustion chamber 18 is a burner 20 in close proximity to the water tank 16. The gas supply assembly 10 of the present invention is designed to deliver fuel to the burner 20 for combustion proximate the water tank 16 thereby heating the water within the tank 16 to a predetermined temperature. The gas supply assembly 10 will be connected to a fuel supply which in one preferred embodiment is natural gas although it is contemplated that the gas supply assembly 10 may be used with other fuel types including propane. The combustion chamber 18 includes an opening 22 to the exterior of the water heater 12 to facilitate access to the gas supply and combustion elements.

The gas supply assembly 10 is disposed within and extends through the opening 22 of the combustion chamber 18. The gas supply assembly 10 includes a door 24 configured to seat within the opening 22 thereby closing this pathway into the combustion chamber 18 (FIG. 2). The door 24 may in one disclosed, non-limiting embodiment of a water heater assembly be at least partially arcuate and approximately 10×3.5 inches in size which typically provides maintenance access, etc. The door 24 defines an interface 26 which provides interconnection between a gas supply line 28 and a gas supply tube 30. The gas supply line 28, in one non-limiting embodiment, may be a flexible line which is connected to the fuel supply. The gas supply tube 30 is, in one non-limiting embodiment, a rigid tube with an outlet port 32 at the burner 20 for delivering the fuel to the burner 20.

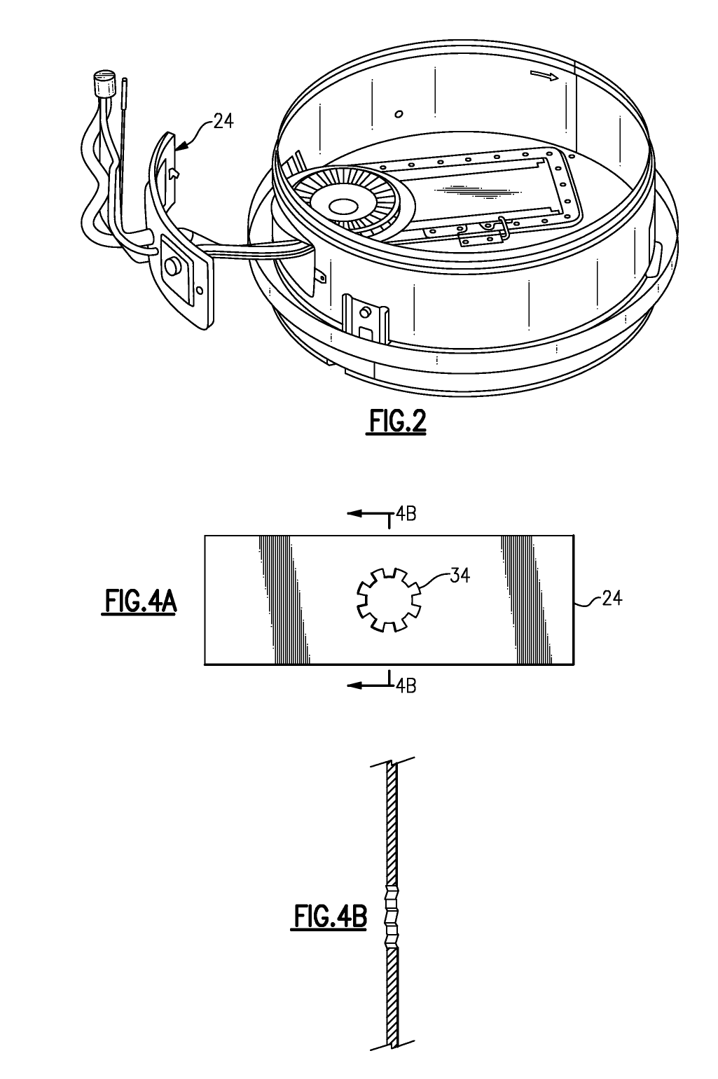

Referring to FIG. 3, the door 24 receives the gas supply line 28 within a serrated opening 34 formed directly therein (also illustrated in FIGS. 4A). The serrated opening 34 is defined by a multiple of teeth or other serrations. That is, the serrated opening 34 is a non-circular opening within the door 24. It should be understood that various serrations may alternatively be provided.

The gas supply tube 30 includes a flange 36 which abuts the door 24 from an inner side thereof when the gas supply tube 30 is inserted within the serrated opening 34. Once the gas supply tube 30 is inserted within the serrated opening 34, the gas supply tube 30 receives the gas supply line 28 directly therein in an overlapped or telescoped relationship at an interface section 40. It should be understood that other male/female receipt arrangements may also be utilized.

A crimp ring 42 provides a metal-to-metal seal between the supply tube 30 and the gas supply line 28 at the interface section 40. One such crimp ring 42 may be a crimp ring manufactured by Lokring of Bartow, Fla. The crimp ring 42 typically includes a ramped inner diameter to provide contact stresses which are sufficiently high to plastically yield a portion of the interface section 40 between the gas supply tube 30 and the gas supply line 28 forming a circumferential, permanent, metal-to-metal seal. The crimp ring 42 facilitates a permanent joint and avoids the usage of elastomeric or rubber seals, O-rings or gaskets which may degrade and leak over time. The crimp ring 42 essentially meets all criteria of a welded connection, except that no heat is required to make the connection.

Once crimped, the crimp ring 42 also essentially compresses the gas supply tube 30 against the serrated opening 34 to prevent the gas supply tube 30 from rotating therein upon assembly. That is, the serrated opening 34 at least partially interfaces with the material build-up which forms the flange 36 to assure a non-rotatable and secure attachment.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A gas supply interface for delivering combustion gases to a combustion chamber of a heating device, said supply interface comprising:
a door adapted to fit within an opening to a combustion chamber, said door defines a serrated opening; and
a gas supply tube which defines a flange, said gas supply tube received within said serrated opening such that said flange abuts said door.

2. The gas supply interface as recited in claim 1, further comprising a gas supply line which telescopes with said gas supply tube.

3. The gas supply interface as recited in claim 2, further comprising a crimp ring which provides a metal-to-metal seal between said gas supply tube and said gas supply line.

4. The gas supply interface as recited in claim 3, wherein said gas supply tube is flexible.

5. The gas supply interface as recited in claim 3, wherein said crimp ring includes a ramped inner surface.

6. A method of assembling a gas supply for delivering combustion gases to a device comprising:
telescoping a gas supply line to a gas supply tube;
inserting the gas supply tube through a serrated opening of a door adapted to fit within an opening to a combustion chamber; and
compressing the gas supply tube against the serrated opening.

7. A method as recited in claim 6, wherein compressing the gas supply tube against the serrated opening provides a metal-to-metal seal.

8. A method as recited in claim 6, wherein compressing the gas supply tube provides a permanent joint between the gas supply tube and the inserting.

9. A method as recited in claim 6, further comprising:
abutting a flange of the gas supply tube with the door opposite the crimp ring.

10. A method as recited in claim 6, wherein compressing the gas supply tube against the serrated opening provides a metal-to-metal seal with a crimp ring.
